(19) United States
(12) Patent Application Publication
(10) Pub. No.: US 2021/0244049 A1
(43) Pub. Date: Aug. 12, 2021

(54) TREATMENT OF POULTRY OR PIGS FOR REDUCING THE FEED CONVERSION RATIO OR INCREASING THEIR BODYWEIGHT GAIN

(71) Applicant: Taminco BVBA, Gent (BE)

(72) Inventors: Peter Roose, Sint-Martens-Latem (BE); An Cools, Leffinge (BE); Nicholas Michael Martyak, Johnsn City, TN (US); Michael Schmidt, Norristown, PA (US); Kenneth Flint, Roanoke, VA (US); Kristof Moonen, Hamme (BE)

(73) Assignee: Taminco BVBA, Gent (BE)

(21) Appl. No.: 16/973,454

(22) PCT Filed: Jun. 13, 2019
(86) PCT No.: PCT/EP2019/065615

§ 371 Date: Dec. 9, 2020

(30) Foreign Application Priority Data
Jun. 15, 2018 (EP) 18178132.9

(51) Int. Cl. A23K 20/163; A23K 10/30; A23K 50/75; A23K 50/30

(52) U.S. Cl. CPC A23K 20/163; A23K 50/30; A23K 50/75; A23K 10/30

(57) ABSTRACT

The invention relates to a method for the treatment of poultry or pigs, including non-therapeutic treatment of poultry or pigs. The treatment comprises orally administering at least one cellulose ester polymer to poultry or pigs in an amount between 0.1 and 10 kg/ton of dry weight of a feed, wherein more than 50% moles of recurring units of the (CE) polymer are recurring units (R_{CE}) of formula (I) as shown below:

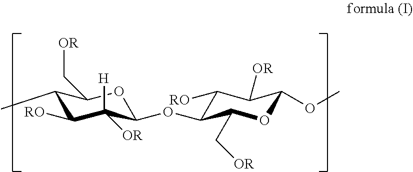

wherein each of R, equal to or different from each other, is H or an acyl group of general formula —(C═O)—R¹ wherein R¹ is an alkyl group having from 1 to 10 carbon atoms, and
wherein the (CE) polymer has a total acyl group content [TAG content, herein after] of at least 5 weight percent (wt. %), relative to the total weight of the (CE) polymer.

### FIELD OF THE INVENTION

The present invention relates to a method for the treatment of poultry or pigs in particular for the purpose of increasing the bodyweight gain of the animals or for the purpose of reducing the conversion ratio of the feed used to feed the poultry or pigs without reducing their bodyweight gain.

### BACKGROUND OF THE INVENTION

In the meat producing industry, improvements and developments have been made essentially in the breeding technique for phyletic lines of the animals and in the rearing technique for increasing the body weight gain thereof. This is especially the case in the broiler and pig industry. Much emphasis is put on the body weight gain of the meat producing animals and the conversion ratio of the feed used to rear them. A high-calorie feed enables to achieve a lower feed conversion ratio, in particular a lower amount of feed is required to produce a certain amount of animal meat or other production parameters such as litres of milk for dairy, total egg weight for layers or total litter weight for reproduction sows. However, a further reduction of the feed conversion ratio is always desired to reduce the production costs. When lowering the feed conversion ratio it is important that the body weight gain is not reduced by the applied treatment. In practice, it is indeed of high economical importance to be able to reduce the feed conversion ratio, i.e. the amount of feed required for 1 kg of productivity, being either gain in body weight without having to use a (more expensive) feed having a higher energy or nutrient value. It is also of high economical importance to be able to increase the body weight gain so that the desired final animal weight can be achieved within a shorter period of time, i.e. so that the meat production cycle can be shortened.

In this respect Shakouri et al. (M. D. Shakouri et al. International Journal of Poultry Science 5 (6): 557-561, 2006) has studied the performance of soluble and insoluble non starch polysaccharides (NSPs) on broiler performance. The addition of the soluble fibers pectin and carboxymethylcellulose (CMC), to diets in an amount of 3% weight relative to the total weight of the diet, decreased the performance of broiler chickens. In particular, a lower weight gain and a higher feed conversion ratio of the birds on these diets was observed. In contrast, the addition of cellulose, an insoluble fiber, in an amount of 3% weight relative to the total weight of the diet, resulted in a better performance of the chickens, in particular weight gain of the chickens increased and the feed conversion ratio decreased.

A. A. Saki at al. also studied the effect of non starch polysaccharides (NSPs) on broiler performance (A. A. Saki at al. Arch. Geflügelk., 74 (3). S. 183-188, 2010 and A. A. Saki at al. World Applied Sciences Journal 15 (2): 192-198, 2011). In particular, the effect of various levels of pectin and cellulose was investigated. Results of this study showed that the interaction between various levels of pectin and cellulose could differently affect performance. Thus the results were completely unpredictable.

In view of the above, there is thus a continuous need for an improved treatment method for poultry or pigs which enables to reduce the conversion ratio of the feed used to feed these animals without reducing however the bodyweight gain, i.e. the average weight gain, or which even enables to increase the bodyweight gain.

### SUMMARY OF THE INVENTION

The inventors have now surprisingly found that it is possible to provide an improved method fulfilling the above mentioned needs.

Thus, there is now provided a method for the treatment of poultry or pigs wherein said treatment comprises orally administering a feed comprising at least one cellulose ester polymer [(CE) polymer, herein after], to poultry or pigs in an amount between 0.1 and 10 kg/ton of dry weight of said feed for the treatment of poultry or pigs, wherein more than 50% moles of recurring units of the (CE) polymer are recurring units (R_{CE}) of formula (I) as shown below:

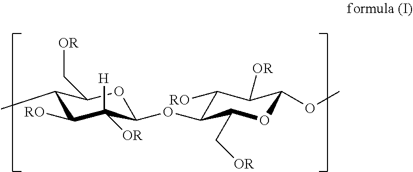

wherein each of R, equal to or different from each other, is H or an acyl group of general formula —(C═O)—R¹ wherein R¹ is an alkyl group having from 1 to 10 carbon atoms, and

wherein the (CE) polymer has a total acyl group content [TAG content, herein after] of at least 5.0 weight percent (wt. %), relative to the total weight of the (CE) polymer.

There is also provided a method for the non-therapeutic treatment of poultry or pigs wherein said treatment comprises orally administering a feed comprising at least one CE polymer to poultry or pigs in an amount between 0.1 and 10 kg/ton of dry weight of said feed for the treatment of poultry or pigs, wherein more than 50% moles of recurring units of the (CE) polymer are recurring units (R_{CE}) of formula (I) as shown below:

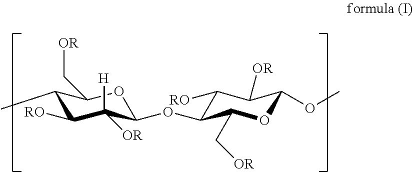

wherein each of R, equal to or different from each other, is H or an acyl group of general formula —(C═O)—R¹ wherein R¹ is an alkyl group having from 1 to 10 carbon atoms, and

wherein the (CE) polymer has a total acyl group content [TAG content, herein after] of at least 5.0 weight percent (wt. %), relative to the total weight of the (CE) polymer.

It is further understood that all definitions and preferences as described in detail for the method for the treatment of poultry or pigs equally apply for the method for the non-therapeutic treatment of poultry or pigs.

The present invention further provides for the use of the (CE) polymer, as detailed above, for reducing the conversion ratio of feed used to feed poultry or pigs, without lowering their bodyweight gain, wherein said (CE) polymer, as detailed above, is orally administered to poultry or pigs in an amount between 0.1 and 10 kg/ton of dry weight of said feed.

The present invention further provides for the use of the (CE) polymer, as detailed above, for increasing the bodyweight gain of the poultry or pigs, i.e. the increase of the bodyweight of the poultry or pigs per time unit, wherein said (CE) polymer, as detailed above, is orally administered to poultry or pigs in an amount between 0.1 and 10 kg/ton of dry weight of said feed.

There is further provided a feed composition comprising:
a) the CE polymer, as detailed above,
b) one or more plant-based food ingredients in a collective amount of at least 50 dry weight percent (dry wt. %), based on the dry weight of the feed composition; and
c) optionally, one or more additional ingredients comprising anti-caking agents, vitamins, mineral, various amino acids, free-flowing agents, animal feed flavors or the like.

The feed composition is suitable as feed for poultry or pigs.

### DETAILED DESCRIPTION

Within the context of the present invention, the expression “at least one cellulose ester polymer [(CE) polymer, herein after]” is intended to denote one or more than one (CE) polymer.

In the rest of the text, the expression “(CE) polymer” is understood, for the purposes of the present invention, both in the plural and the singular, that is to say that for example the feed may comprise one or more than one (CE) polymer.

Within the context of the present invention, the expression “conversion ratio of feed” refers to a measure of an animal's efficiency in converting feed mass into increased body mass (e.g. muscle or egg mass for poultry).

Within the context of the present invention, the expression “conversion ratio of feed” is calculated by dividing the average daily feed intake by the average daily bodyweight gain of the poultry or pigs, all over a specified period.

As used in the foregoing and hereinafter, the following definitions apply unless otherwise noted.

The term “alkyl”, alone or in combination means an alkane-derived radical, which may be a straight chain alkyl, branched alkyl or cyclic alkyl, containing from 1 to 10 carbon atoms, unless otherwise specified. The straight chain or branched alkyl group is attached at any available point to produce a stable compound. Alkyl also includes a straight chain or branched alkyl group that contains or is interrupted by a cycloalkyl portion. According to certain embodiments C_{A-B} alkyl defines a straight or branched alkyl radical having from A to B carbon atoms, e.g. C₁₋₁₀ alkyl defines a straight or branched alkyl radical having from 1 to 10 carbon atoms, C₁₋₆ alkyl defines a straight or branched alkyl radical having from 1 to 6 carbon atoms such as for example methyl, ethyl, 1-propyl, 2-propyl, 1-butyl, 2-butyl, 2-methyl-1-propyl. According to certain embodiments a cyclic C_{C-D} alkyl defines a cyclic alkyl radical having from C to D carbon atoms, e.g. C₃₋₆ cyclic alkyl.

In a preferred embodiment of the method according to the present invention, R¹ in the acyl group of general formula —(C═O)—R¹ is an alkyl group having from 1 to 6 carbon atoms, or from 1 to 4 carbon atoms, or each of R¹, equal to or different from each other, is independently selected from methyl, ethyl, propyl, isopropyl, n-butyl, s-butyl, t-butyl or isobutyl. Desirably, each of R¹, equal to or different from each other, is independently selected from methyl, propyl, or n-butyl.

Preferred recurring units (R_{CE}) of formula (I) as shown above, are those selected wherein each of R, equal to or different from each other, is H, an acetyl, a propionyl or a butyryl group.

More preferred recurring units (R_{CE}) of formula (I) as shown above, are those selected wherein each of R, equal to or different from each other, is H, an acetyl, or a butyryl group.

In an embodiment of the method according to the present invention, in the (CE) polymer, as detailed above, more than 60 wt. %, or more than 80 wt. %, more or more than 90 wt. %, or more than 95 wt. % of the recurring units are recurring units (R_{CE}) of formula (I), as detailed above.

Still, it is generally preferred that substantially all recurring units of the (CE) polymer are recurring units (R_{CE}) of formula (I), as detailed above, chain defects, or very minor amounts of other units might be present, being understood that these latter do not substantially modify the properties of the (CE) polymer.

Within the context of the present invention, the expression “a total acyl group content [TAG content, herein after]” is intended to refer to the total weight of all the R acyl group of general formula —(C═O)—R¹, as detailed above, relative to the total weight of the (CE) polymer.

As said, the TAG content of the (CE) polymer is of at least 5 wt. %, relative to the total weight of the (CE) polymer, or equal to or at least 10 wt. %, or equal to or at least 15 wt. %, or equal to or at least 20 wt. %, or equal to or at least 25 wt. %, or equal to or at least 30 wt. %, or equal to or at least 35 wt. %, or equal to or at least 37 wt. %, or equal to or at least 40 wt. %, or equal to or at least 45 wt. %.

It is further understood that the upper limit of the TAG content of the (CE) polymer, relative to the total weight of the (CE) polymer, is not restricted and can be as high as complete substitution of all hydroxyl groups. In general, the TAG content of the (CE) polymer is less than 60 wt. %, or less than 55 wt. %, relative to the total weight of the (CE) polymer.

The particular TAG content of the (CE) polymer, relative to the total weight of the (CE) polymer selected will depend on the type of acyl group substituents bonded to the cellulose ester backbone, as well as the properties desired. An increase in the TAG content generally renders the (CE) polymer more hydrophobic, increases it Tg, and improves its flexibility. Suitable ranges of TAG content on a weight % basis range from 15 to 60, or 15 to 55, or 20 to 60, or 20 to 55, or 25 to 60, or 25 to 55, or 30 to 60, or 30 to 55, or 35 to 60, or 35 to 55, 37 to 60, or 37 to 55, or 40 to 60, or 40 to 55, or 45 to 60, or 45 to 55.

In a preferred embodiment of the method according to the present invention, the TAG content of the (CE) polymer, relative to the total weight of the (CE) polymer, ranges from 40 wt. % to 60 wt. %, or from 45 wt. % to 60 wt. %, or from 45 wt. % to 55 wt. %.

In one embodiment of the method according to the present invention, the (CE) polymer, as detailed above, has advantageously a number average molecular weight (Mₙ) of at least 1,000, or at least 1,500, or at least 6,000, or at least 10,000, or at least 12,000, or at least 15,000, or at least 20,000, or at least 25,000, or at least 30,000, or at least 35,000, or at least 40,000, or at least 45,000, or at least 50,000, or at least about 55,000.

Upper limit for the number average molecular weight (Mₙ) of the (CE) polymer is not particularly critical and will be selected by the skilled in the art in view of the type of acyl group substituents bonded to the cellulose ester backbone.

In one embodiment of the method according to the present invention, the (CE) polymer, as detailed above, has advantageously a number average molecular weight (Mₙ) below 120,000, or below 100,000, or below 85,000, or below 70,000, or below 65,000, or below 60,000.

In one embodiment of the method according to the present invention, the (CE) polymer, as detailed above, has a number average molecular weight (Mₙ) ranging from 1,500 to 85,000, more or from 10,000 to 85,000, or from 12,000 to 70,000, and even from 15,000 to 65,000.

The expression “number average molecular weight (Mₙ)” is hereby used according to its usual meaning and mathematically expressed as:

$${M}_{n} = \frac{\sum {M}_{i} \cdot {N}_{i}}{\sum {N}_{i}}$$

wherein Mᵢ is the discrete value for the molecular weight of polymer molecule, Nᵢ is the number of polymer molecules with molecular weight Mᵢ, then the weight of all polymer molecules is ΣMᵢNᵢ and the total number of polymer molecules is ΣNᵢ.

Mₙ can be suitably determined by chromatography methods, such as size exclusion chromatography, calibrated with polystyrene standards or gel permeation chromatography (GPC), calibrated with polystyrene standards.

In general for cellulose esters, the substitution level is usually expressed in terms of degree of substitution [DS, herein after], which is the average number of substituents per anhydroglucose unit (“AGU”).

The recurring unit (RCE) of formula (I), as detailed above, has 2 AGUs.

Advantageously, the (CE) polymer, as detailed above, used in the present invention, has a degree of polymerization [(DP), herein after] of at least 5, of at least 10, of at least 20, of at least 25, or at least 30, or at least 40, or at least 50, or at least 60, or at least 70, or at least 80, or at least 90, or at least 100, or at least 100, or at least 110, or at least 120, or at least 130, or at least 140, or at least 150, or at least 160.

Upper limit for the (DP) of the (CE) polymer is not particularly critical and will be selected by the skilled in the art. Although, the (CE) polymer, as detailed above, has advantageously a (DP) of below 350, or below 300, or below 280, or below 250, or below 230, or below 200.

Within the context of the present invention, the expression “a degree of polymerization [(DP), herein after]” is intended to refer to the total the number of AGUs per (CE) polymer.

Generally, conventional cellulose contains three hydroxyl groups per AGU that can be substituted; therefore, the DS can have a value between zero and three. Generally, cellulose is a large polysaccharide with a degree of polymerization from 110 to 375 and a maximum DS of 3.0.

Within the context of the present invention, the expression “DS” is intended to refer to a statistical mean value. This being said, it means that a DS value of 1 does not assure that every AGU has a single substituent. In some cases, in the (CE) polymer used in the present, some of the AGUs can be unsubstituted, some of the AGUs can have two substituents, and some have three substituents.

Within the context of the present invention, the expression “total DS” is intended to refer to the average number of all acyl groups of general formula —(C═O)—R¹, as detailed above, per AGU.

In one embodiment of the method according to the present invention, the (CE) polymer can have a total DS per AGU [(total DS)/AGU, herein after] of at least 1.0, or at least 1.2, or at least 1.5, or at least 1.7, or at least 1.9, or at least 2.0, or at least 2.2, or at least 2.3, or at least 2.4, or at least 2.5, and can be up to 3.5, or up to 3.3, or up to 3.0, or up 2.9, or up to 2.8.

In a preferred embodiment of the method according to the present invention, the (CE) polymer, as detailed above, has a (total DS)/AGU ranging from 2.0 to 3.5, or from 2.0 to 3.0, even from 2.2 to 3.0.

According to certain embodiments of the method of the present invention, the (CE) polymer has advantageously an acetyl group content [AG content, herein after] of less than 60 wt. %, or less than 50 wt. %, or less than 45 wt. %, or less than 40 wt. %, or less than 35 wt. %, or less than 30 wt. %, or less than 25 wt. %, or less than 20 wt. %, or less than 15 wt. %, or less than 10 wt. %, or less than 8 wt. %, or less than 5 wt. %, relative to the total weight of the (CE) polymer.

The lower limit for the AG content of the (CE) polymer is not particularly critical and is in general higher than 0.5 wt. %, or higher than 1 wt. % or higher than 2 wt. %, relative to the total weight of the (CE) polymer.

In a preferred embodiment of the method according to the present invention, the (CE) polymer, as detailed above, has an AG content ranging from 0.5 wt. % to 15 wt. %, or from 1 wt. % to 10 wt. %, or from 1.5 wt. % to 8 wt. %, even from 2 wt. % to 5 wt. %.

Within the context of the present invention, the expression “an acetyl group content [AG content, herein after]” is intended to refer to the total weight of the acetyl groups, relative to the total weight of the (CE) polymer.

According to certain embodiments of the method of the present invention, the (CE) polymer has advantageously an average number of acetyl groups per AGU [DS_{AC}/AGU, herein after] of less than 3.0, or less than 2.5, or less than 2.0, or less than 1.5, or less than 1.0, or less than 0.8, or less than 0.5, or less than 0.4.

The lower limit for DS_{AC}/AGU of the (CE) polymer is not particularly critical and can be even 0. In general, DS_{AC}/AGU of the (CE) polymer is higher than 0.01, or higher than 0.05 or higher than 0.10.

In a preferred embodiment of the method according to the present invention, the (CE) polymer, as detailed above, has a DS_{AC}/AGU ranging from 0.05 to 2.0, or from 0.10 to 1.0, desirably from 0.10 to 0.4.

According to certain embodiments of the method of the present invention, the (CE) polymer has advantageously a propionyl group content [PG content, herein after] of at least 10 wt. %, or equal to or at least 15 wt. %, or equal to or at least 20, or equal to or at least 25 wt. %, or equal to or at least 30 wt. %, or equal to or at least 35 wt. %, or equal to or at least 37 wt. %, or equal to or at least 40 wt. %, or equal to or at least 45 wt. %.

It is further understood that the upper limit of the PG content of the (CE) polymer, relative to the total weight of the (CE) polymer, is not restricted. In general, the PG content of the (CE) polymer is less than 60 wt. %, or less than 55 wt. %, relative to the total weight of the (CE) polymer.

According to an alternative embodiment of the method of the present invention, the (CE) polymer is substantially free of propionyl groups.

For the purpose of the present invention, the expression “substantially free of propionyl groups” means that the PG content is lower than 1 wt. %, or lower than 0.5 wt. %, or lower than 0.01 wt. %, or lower than 0.005 wt. %, specifically lower than 0.001 wt. %.

Within the context of the present invention, the expression “propionyl group content [PG content, herein after]” is intended to refer to the total weight of the propionyl groups, relative to the total weight of the (CE) polymer.

According to certain embodiments of the method of the present invention, the (CE) polymer has advantageously an average number of propionyl groups per AGU [DS_{PR}/AGU, herein after] of at least 0.5, or of at least 1.0, or at least 1.2, or at least 1.5, or at least 1.7, or at least 1.9, or at least 2.0, or at least 2.2, or at least 2.3, or at least 2.4, or at least 2.5, and can be up to 3.5, or up to 3.3, or up to 3.0, or up 2.9, or up to 2.8.

According to certain embodiments of the method of the present invention, the (CE) polymer has advantageously a butyryl group content [BG content, herein after] of at least 5 wt. %, or equal to or at least 10 wt. %, or equal to or at least 15 wt. %, or equal to or at least 20, or equal to or at least 25 wt. %, or equal to or at least 30 wt. %, or equal to or at least 35 wt. %, or equal to or at least 37 wt. %, or equal to or at least 40 wt. %, or equal to or at least 45 wt. %.

It is further understood that the upper limit of the BG content of the (CE) polymer, relative to the total weight of the (CE) polymer, is not restricted. In general, the BG content of the (CE) polymer is less than 60 wt. %, or less than 55 wt. %, relative to the total weight of the (CE) polymer.

In a preferred embodiment of the method according to the present invention, the (CE) polymer, as detailed above, has an BG content ranging from 30 wt. % to 60 wt. %, or from 35 wt. % to 60 wt. %, or from 40 wt. % to 58 wt. %, even from 45 wt. % to 55 wt. %.

Within the context of the present invention, the expression “butyryl group content [BG content, herein after]” is intended to refer to the total weight of the butyryl group, relative to the total weight of the (CE) polymer.

According to certain embodiments of the method of the present invention, the (CE) polymer has advantageously an average number of butyryl groups per AGU [DS_{BU}/AGU, herein after] of at least 0.1, of at least 0.5, of at least 1.0, or at least 1.2, or at least 1.5, or at least 1.7, or at least 1.9, or at least 2.0, or at least 2.2, or at least 2.3, or at least 2.4, or at least 2.5, and can be up to 3.5, or up to 3.3, or up to 3.0, or up 2.9, or up to 2.8.

In a preferred embodiment of the method according to the present invention, the (CE) polymer, as detailed above, has a DS_{BU}/AGU ranging from 0.5 to 3.0, or from 1.5 to 3.0, even from 2.0 to 3.0.

According to certain embodiments of the method of the present invention, the (CE) polymer, as detailed above, comprises at least acetyl groups and butyryl groups wherein the BG content ranges from 35 wt. % to 58 wt. % and the AG content ranges from 0.5 wt. % to 10 wt. %, or the BG content ranges from 40 wt. % to 55 wt. % and the AG content ranges from 1.0 wt. % to 5 wt. %, or desirably the BG content ranges from 45 wt. % to 55 wt. % and the AG content ranges from 2 wt. % to 4 wt. %.

Advantageously, the acetyl groups and butyryl groups in the (CE) polymer, as detailed above, are both present in a molar ratio butyryl groups to acetyl groups varying from 0.5 to 18.0, or 1.0 to 16.0, or from 3.0 to 15.0, or from 5.0 to 14.0.

According to certain embodiments of the method of the present invention, the (CE) polymer, as detailed above, comprises at least acetyl groups and butyryl groups wherein the BG content ranges from 25 wt. % to 50 wt. % and the AG content ranges from 5 wt. % to 30 wt. %, or the BG content ranges from 25 wt. % to 45 wt. % and the AG content ranges from 8 wt. % to 25 wt. %, or desirably the BG content ranges from 30 wt. % to 40 wt. % and the AG content ranges from 10 wt. % to 20 wt. %.

According to certain embodiments of the method of the present invention, the (CE) polymer has advantageously a hydroxyl content [OH content, herein after] of less than 10.0 wt. %, or less than 8.0 wt. %, or less than 6.0 wt. %, or less than 4.0 wt. %, or less than 3.5 wt. %, or less than 3.0 wt. %, or less than 2.5 wt. %, or less than 2.0 wt. %, relative to the total weight of the (CE) polymer.

The lower limit for the OH content of the (CE) polymer is not particularly critical and is in general higher than 0.1 wt. %, or higher than 0.5 wt. %, relative to the total weight of the (CE) polymer.

In one embodiment of the method according to the present invention, the (CE) polymer, as detailed above, has an OH content ranging from 0.1 wt. % to 6.0 wt. %, or from 0.5 wt. % to 5.0 wt. %, or from 0.5 wt. % to 2.5 wt. %. Within the context of the present invention, the expression “a hydroxyl content [OH content, herein after]” is intended to refer to the total weight of the hydroxyl groups, relative to the total weight of the (CE) polymer.

The determination of the total (DS)/AGU, DS_{AC}/AGU, DS_{PR}/AGU, and DS_{BU}/AGU, the TAG content, AG content, PG content, BG content, and OH content, can be realised by using known analytical methods in the art, such as notably NMR methods and GPC methods. In general, the TAG content, AG content, PG content, BG content, and OH content are calculated from the corresponding DS data as notably described in U.S. Pat. No. 7,585,905, the whole content of which is also herein incorporated by reference.

Non limitative examples of commercially available (CE) polymers suitable for the invention include the commercial higher butyryl-content samples such as CAB-551-0.01 (cellulose acetate butyrate containing approximately 55 wt. % butyryl, available from Eastman Chemical Company.

It is further understood that all definitions and preferences as described for the (CE) polymer above equally apply for all further embodiments, as described below.

The (CE) polymer can be prepared by any method known in the art for the manufacture of cellulose esters.

Examples of processes for producing cellulose esters are taught in Kirk-Othmer, Encyclopedia of Chemical Technology, 5th Edition, Vol. 5, Wiley-Interscience, New York (2004), pp. 394-444. Cellulose, the starting material for producing cellulose esters, can be obtained in different grades and from sources such as, for example, cotton linters, softwood pulp, hardwood pulp, corn fiber and other agricultural sources, and bacterial celluloses.

One method of producing cellulose esters is by esterification. In such a method, the cellulose is mixed with the appropriate organic acids, acid anhydrides, and catalysts and then converted to a cellulose triester. Ester hydrolysis is then performed by adding a water-acid mixture to the cellulose triester, which can be filtered to remove any gel particles or fibers. Water is added to the mixture to precipitate out the cellulose ester. The cellulose ester can be washed with water to remove reaction by-products followed by dewatering and drying.

Alternatively, cellulose triesters can also be prepared by heterogeneous acylation of cellulose in a mixture of carboxylic acid and anhydride in the presence of a catalyst such as H₂SO₄ or by the homogeneous acylation of cellulose dissolved in an appropriate solvent such as LiCl/DMAc or LiCl/NMP.

After esterification of the cellulose to the triester, part of the acyl substituents can be removed by hydrolysis or by alcoholysis to give a secondary cellulose ester. Secondary cellulose esters can also be prepared directly with no hydrolysis by using a limiting amount of acylating reagent. This process is particularly useful when the reaction is conducted in a solvent that will dissolve cellulose.

The manufacture of cellulose esters are notably described in U.S. Pat. Nos. 1,698,049; 1,683,347; 1,880.808; 1,880,560; 1,984,147, 2,129,052; and 3,617,201, which are incorporated herein by reference in their entirety to the extent they do not contradict the statements herein.

As discussed above, it was already described in the prior art that the addition of cellulose, an insoluble fiber, in an amount of 3% weight to a control diet relative to the total weight of said control diet, resulted in a better performance of broiler chickens (i.e. a higher feed intake and weight gain and a lower feed conversion ratio of broiler chickens). It was demonstrated in the examples below that the addition of only 0.1% by weight of cellulose to the control diet resulted in a decrease of the final body weight of the bird.

The inventors have now surprisingly found that when cellulose is further modified by incorporation of acyl groups of general formula —(C═O)—R¹ wherein R¹ is an alkyl group having from 2 to 10 carbon atoms wherein the acyl groups are present in the (CE) polymer; as detailed above, in an amount of at least 5 wt. %, relative to the total weight of the (CE) polymer, an increase of the body weight gain or an increase of the body weight gain combined with a reduction of the feed conversion ratio can be obtained, as evidenced by the examples below. Moreover, small amounts of the (CE) polymer comprised between 0.1 and 10 kg/ton of dry weight of the feed, can be used thereby resulting in a smaller cost for the supplementation of the feed with this feed additive.

Another aspect of the present invention is a feed for poultry or pigs comprising between 0.1 and 10 kg/ton of the (CE) polymer, as detailed above, relative to the dry weight of said feed wherein the (CE) polymer has a BG content of at least 5 wt. %, or equal to or of at least 10 wt. %, or equal to or at least 15 wt. %, or equal to or at least 20, or equal to or at least 25 wt. %, or equal to or at least 30 wt. %, or equal to or at least 35 wt. %, or equal to or at least 37 wt. %, or equal to or at least 40 wt. %, or equal to or at least 45 wt. %.

In a preferred embodiment of the invention, the preferred amount of the (CE) polymer; as detailed above in the finished feed is at least 0.5 kg/ton, or at least 0.8 kg/ton, or at least 1.0 kg/ton, or desirably at least 1.5 kg/ton dry weight of said feed when used for the treatment of poultry (i.e. chickens or turkeys) or pigs. The maximum amount of the (CE) polymer in the finished feed is desirably less than 8 kg/ton, or less than 7 kg/ton, or less than 6 kg/ton, more or less than 5 kg/ton and more or less than 4.5 kg/ton dry weight of said feed, when used for the treatment of poultry or pigs.

The present invention is applicable to any type of commercial meat production operation. The animals are poultry (i.e. chickens or turkeys), or pigs. In commercial pig and poultry production operation the herd is typically under substantial stress. As is well known, normal industry growing conditions include substantial density in the enclosure. Further, this implies high pressure of pathogens present in the environment that could result in impaired functioning of the gastrointestinal system with suboptimal digestive capacity as a consequence. For broilers, the life span moreover ranges from about 28 to about 56 days whilst the lifespan for turkeys ranges from 12 to 24 weeks. The life span for slaughter pigs is around 6 months whilst sows are usually removed after 6 reproductive cycles on average. Both for poultry and for pigs the whole operation from birth to market in conditions under which growth/reproduction is achieved is therefore very stressful. Moreover, to aggravate the problem, growers will typically push the limits of recommended industry conditions which simply increases the stress on the flock or herd.

Due to these high-performance conditions and the high stoking density, the occurrence level of digestive problems is already quite high in practice and limits the development of new feeds or production methods which cause even more digestive or indirect metabolic stress. As a result of this, there is a high need for a well maintained and robust gut health. The importance of nutritional solutions that support gut health and optimal functionality of the digestive systems is of utmost importance. Especially considering the growing awareness of development of resistance to antibiotics, the need for nutritional solutions supporting an optimal functionality of the digestive system is gaining importance.

There is also provided, in an embodiment of the present invention, a feed composition comprising the (CE) polymer, as detailed above.

The feed composition, which is suitable as a feed for poultry or pigs, comprises:
a) the CE polymer, as detailed above,
and either of or both of
b) one or more plant-based food ingredients in a collective amount of at least 50 dry weight percent (dry wt. %), based on the dry weight of the feed composition; and
c) one or more additional ingredients comprising anti-caking agents, vitamins, mineral, various amino acids, free-flowing agents, animal feed flavors or the like.

The CE polymer in the feed composition includes any of the embodiments of CE polymer described above.

The feed composition is in particular a feed or a premix for producing said feed.

The plant-based food ingredients may comprise grains and/or vegetables. Examples, of suitable grains include wheat, corn, millet, barley, oats, and legumes such as soybeans Examples of suitable vegetables include cabbage, broccoli, beets, sweet corn, lettuce, spinach, wheatgrass, turnip greens, chard, collard greens, and the like.

In general, a premix is comprising said CE polymer and at least one of said additional ingredients, in particular one or more vitamins, minerals, or the like. It comprises a combination of these ingredients, and optionally of one or more carrier materials, so that a large amount can be added thereof to the feed in order to make dosing of the additional ingredients, which are usually, only required in small amounts, easier.

Advantageously, the pre-mix containing the CE polymer, as detailed above, can be blended with the plant-based food ingredients to produce the feed. Alternatively, instead of including the CE polymer in a premix, it can be added directly to the plant-based food ingredients. Alternatively, the CE polymer, the one or more plant-based food ingredients, and the one or more additional ingredients can be blended at the same time to produce the feed, whereby a number of the additional ingredients may, optionally be combined in a premix (optionally together with the CE polymer).

It is further understood that the feed composition (including pre-mixes) do not contain any added ingredients or food contaminants that are poisons or toxins, e.g. substances that have an inherent property and in amounts to induce death or induce illness in insects or mammals, including poultry or pigs.

According to certain embodiments of the present invention, the feed composition also may comprise the absence of refined and isolated cellulose type compounds different to the (CE) polymers of the present invention, such as notably cellulose, carboxymethyl cellulose (CMC), and the like, or if present, are in amounts lower than 10 wt. %, or lower than 5 wt. %, or lower than 2 wt. %, or lower than 1 wt. %, or lower than 0.5 wt. %, or lower than 0.1 wt. %, relative to the total weight of the feed composition.

If desired, the feed composition is substantially free of refined and isolated cellulose type compounds different to the (CE) polymers of the present invention, such as notably cellulose, carboxymethyl cellulose (CMC), and the like.

For the purpose of the present invention, the expression “substantially free of refined and isolated cellulose type compounds different to the (CE) polymers of the present invention” means that the amount of said other cellulose type compounds is lower than 0.01 wt. %, in particular lower than 0.005 wt. %, specifically lower than 0.001 wt. %, more specifically lower than 0.0005 wt. %, even more specifically lower than 0.0001 wt. %.

When the (CE) polymer, as detailed above, is water-soluble, it can be dosed in the drinking water of the animals. Desirably, the (CE) polymer, as detailed above, or the feed composition is however administered via the feed.

Alternatively, the feed composition is orally administering to poultry or pigs.

The (CE) polymer, as detailed above, or the feed composition can either be added directly to the feed.

Alternatively, the (CE) polymer can either be added to a feed supplement, in particular a so-called premix, which is usually used to prepare the feed. Such a feed supplement generally comprises at least vitamins and optionally minerals.

The CE polymer is advantageously in a solid form. The feed composition is in particular a granular composition. The solid CE polymer may be contained in the granules of the feed composition that also contain one or more other components of the feed composition. Desirably, the CE polymer is in particular distributed within and throughout the granules. The granules with the CE polymer are desirably feed pellets. These feed pellets may contain said one or more plant-based food ingredients. Instead of, or in addition to being contained in the granules of the granular feed composition that contain said one or more plant-based food ingredient, the solid CE polymer can be in the form of solid particles that are mixed with the feed granules. Said solid particles may be in different forms including, but not limited to, powders, granules, capsules, tablets, and pills.

Such feed compositions or feeds in these forms can be prepared by known processes using known methods in the art.

The (CE) polymer, as detailed above, is desirably administered over a period of 7 days or longer, preferably over a period of 14 days or longer.

### Experimental Results

### Poultry in Mash Feed:

### Materials and Methods

A group of 660 Ross 308 one day old male chickens were randomly distributed over 44 pens with 15 animals each. Pens were randomly assigned to one out of six treatments. Six pens were assigned to both negative and positive control treatments and eight pens were assigned to each of the four cellulose ester treatments. Water was freely available from drinking cups, and animals were fed ad libitum. A three-phase feeding scheme was applied for all pens. Starter, grower and finisher diets were formulated to meet energy and nutrient requirements according to CVB 2012 guidelines. The composition of these diets is shown in Table 1.1 and the nutrient composition is given in Table 2.1. The starter diet was provided from day 1 until day 14, the grower diet was provided from day 14 until day 28 and finisher diets was provided from day 28 until day 37.

TABLE 1.1
Ingredient composition of the experimental diet.

| Ingredient | Starter g/kg | Grower g/kg | Finisher g/kg |
|---|---|---|---|
| Wheat | 474.9 | 491.2 | 535.6 |
| Corn | 100.0 | 100.0 | 100.0 |
| Toasted soybean meal | 197.9 | 184.5 | 133.6 |
| Toasted extruded soybeans | 150.0 | 150.0 | 113.0 |
| Triglycerides | 35.5 | 23.7 | 23.5 |
| Soy oil | — | 12.3 | 19.4 |
| Corn gluten feed | — | — | 22.8 |
| Limestone | 20.3 | 17.8 | 17.7 |
| Sunflower meal | — | — | 12.0 |
| Mono calcium phosphate | — | — | 1.3 |
| Premix* | 20.0 | 20.0 | 20.0 |
| L-lysine HCl | 0.2 | — | 0.8 |
| DL-methionine | 0.5 | 0.2 | — |
| L-threonine | 0.6 | 0.2 | 0.2 |
| Phytase | 0.1 | 0.1 | 0.1 |

*Premix contains per kg of premix: vitamin A: 675 000 IU/kg, vitamin D3: 125 000 IU/kg, vitamin E: 2525 IU/kg, vitamin B1: 0.15 mg/kg, vitamin B2: 0.30 mg/kg, vitamin B3: 0.92 mg/kg, niacine: 2.23 mg/kg, vitamin B6: 0.34 mg/kg, vitamin B12: 1.69 mg/kg, biotine: 7.5 mg/kg, choline: 30 202 mg/kg, propylgallate: 0.04 mg/kg, citric acid: 30 mg/kg, Cu (from Cu sulphate): 563 mg/kg, Fe (from Fe sulphate): 3750 mg/kg, I (from Ca iodate): 56 mg/kg, Mn (from Mn oxide): 1846 mg/kg, Zn (from zinc sulphate): 3750 mg/kg, Se (from sodium selenite): 15 mg/kg.

TABLE 2.1
Nutrient composition of the experimental diets.

| Nutrient | Starter | Grower | Finisher |
|---|---|---|---|
| Dry matter, g/kg | 882.0 | 881.3 | 881.1 |
| Ash, g/kg | 53.8 | 50.6 | 48.3 |
| Crude protein, g/kg | 215.0 | 210.0 | 195.0 |
| Ether extract, g/kg | 79.5 | 80.0 | 80.0 |
| Crude fibre, g/kg | 32.0 | 31.9 | 32.0 |
| Nitrogen-free extract, g/kg | 501.7 | 508.8 | 525.8 |
| Metabolisable energy, kCal/kg | 2825 | 2860 | 2925 |
| Methionine, g/kg | 6.27 | 5.97 | 5.69 |
| Lysine, g/kg | 13.25 | 12.77 | 11.57 |
| P, g/kg | 3.91 | 3.87 | 4.00 |
| Ca, g/kg | 9.00 | 8.00 | 8.00 |
| Na, g/kg | 1.45 | 1.45 | 1.45 |

The diets, as described in Table 3.1B, were produced in mash form and supplemented with pure crystalline cellulose for the positive control, and with several types of cellulose esters (i.e. (CE) polymers according to the invention) having the general formula (II). The characteristics of the cellulose esters 1 to 4 (CE 1 to CE4) are summarized in Table 3.1 A.

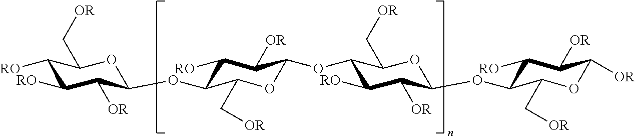

wherein each of R, equal to or different from each other, is H, an acetyl, or a butyryl group.

TABLE 3.1A
Overview of the characteristics of the cellulose esters 1 to 4

| | (total | | | | | |
|---|---|---|---|---|---|---|
| | DS)/ | DS_{BU}/ | BG | AG | DS_{AC}/ | ^{a}Mₙ × |
| — | AGU | AGU | content | content | AGU | 1000 |
| CE1 | 3.00 | 2.5 | 52 wt. % | 2 wt. % | 0.2 | 30 |
| CE2 | 3.00 | 2.6 | 53 wt. % | 2 wt. % | 0.2 | 16 |
| CE3 | 3.00 | 2.5 | 51 wt. % | 4 wt. % | 0.3 | 57 |
| CE4 | 3.08-3.50 | 2.11-2.91 | — | — | 0.1-0.5 | 1.5-10 |

^{a}Number-average molecular weight values are polystyrene-equivalent molecular weights determined using size exclusion chromatography.

The acetyl and butyryl weight percents can be determined by a hydrolysis GC method. In this method, about 1 g of ester is weighed into a weighing bottle and dried in a vacuum oven at 105° C. for at least 30 minutes. Then 0.5000.001 g of sample is weighed into a 250 mL Erlenmeyer flask. To this flask is added 50 mL of a solution of 9.16 g isovaleric acid, 99/a, in 2000 mL pyridine. This mixture is heated to reflux for about 10 minutes, after which 30 mL of isopropanolic potassium hydroxide solution is added. This mixture is heated at reflux for about 10 minutes. The mixture is allowed to cool with stirring for 20 minutes, and then 3 mL of concentrated hydrochloric acid is added. The mixture is stirred for 5 minutes, and then allowed to settle for 5 minutes. About 3 mL of solution is transferred to a centrifuge tube and centrifuged for about 5 minutes. The liquid is analyzed by GC (split injection and flame ionization detector) with a 25M×0.53 mm fused silica column with 1 μm FFAP phase.

The weight percent acyl is calculated as follows, where:
Cᵢ=concentration of I (acyl group)
Fᵢ=relative response factor for component I
Fₛ=relative response factor for isovaleric acid
Aᵢ=area of component I
Aₛ=area of isovaleric acid
R=(grams of isovaleric acid)/(g sample)
Cᵢ=((Fᵢ*Aᵢ)/Fₛ*Aₛ))*R*100

The wt. % substitutions may be converted to degree of substitution (DS) values, according to the following:

Wt. % Butyryl is calculated using the following equation:

Wt.% Bu=(DS_{Bu}*MW_{Bu})/((DS_{Ac}*MW_{AcKet})+(DS_{Bu}*MW_{BuKet})+MW_{anhydroglu})

Wt. % Acetyl is calculated using the following equation:

Wt. % Ac=(DS_{Ac}*MW_{Ac})/((DS_{Ac}*MW_{AcKet})+(DS_{Bu}*MW_{BuKet})+MW_{anhydroglu})

Wherein
MW_{Ac}=Molecular weight of the acetyl ester, (C₂H₃O=43.045)
MW_{Bu}=Molecular weight of the butyryl ester, (C₄H₇O=71.095)
MW_{AcKet}=Molecular weight of the acetyl ester minus one hydrogen, (C₂H₂O=42.037)
MW_{BuKet}=Molecular weight of the acetyl ester minus one hydrogen, (C₄H₆O=70.091)
MW_{anhydroglu}=Molecular weight of the anhydroglucose unit, (C₆H₁₀O₅=162.141)

The cellulose esters 1 to 4 (CE1 to CE4) have higher number-average molecular weight values, therefore it is accepted that the (total DS)/AGU is 3.0.

For the cellulose ester 4 (CE4), the DS_{BU}/AGU and DS_{AC}/AGU were also derived from the acetyl and butyryl weight percents as determined by the hydrolysis GC method, as detailed above.

For the determination of the (total DS)/AGU value, the Wt. % Hydroxyl was determined by titration and the (total DS)/AGU value was derived from using the following equation:

Wt.% OH=(DS_{Max}−DS_{Ac}−DS_{Bu})*MW_{OH}/((DS_{AC}*MW_{AcKet})+(DS_{Bu}*MW_{BuKet})+MW_{anhydroglu})

TABLE 3.1
Overview of the different treatments with the amount
of additive added on top of the blank feed.

| Dietary treatment | Number of pens | Starter | Grower | Finisher |
|---|---|---|---|---|
| Negative control | 6 | Blank feed | Blank feed | Blank feed |
| Positive control | 6 | 1 kg/ton | 1 kg/ton | 1 kg/ton |
| | | pure | pure | pure |
| | | cellulose | cellulose | cellulose |
| Cellulose ester 1 | 8 | 2 kg/ton | 2 kg/ton | 2 kg/ton |
| | | cellulose | cellulose | cellulose |
| | | ester 1 | ester 1 | ester 1 |
| Cellulose ester 2 | 8 | 2 kg/ton | 2 kg/ton | 2 kg/ton |
| | | cellulose | cellulose | cellulose |
| | | ester 2 | ester 2 | ester 2 |
| Cellulose ester 3 | 8 | 2 kg/ton | 2 kg/ton | 2 kg/ton |
| | | cellulose | cellulose | cellulose |
| | | ester 3 | ester 3 | ester 3 |
| Cellulose ester 4 | 8 | 2 kg/ton | 2 kg/ton | 2 kg/ton |
| | | cellulose | cellulose | cellulose |
| | | ester 4 | ester 4 | ester 4 |

From day 1 until day 37, the change in bodyweight was measured per pen together with feed intake per pen.

Results

The birds in the four cellulose ester groups had an increased final body weight compared to the negative control but also compared to the positive control. Consequently, average daily gain was increased for all cellulose ester groups with an average daily feed intake equal of lower than the negative control group. This results in improved feed conversion rates for all cellulose ester groups. An overview of the results is show in Table 4.1.

TABLE 4.1
Effect of cellulose and cellulose ester supplementation on
broiler chicken performance between 1 and 37 days of age.

| | | Average daily | Average daily | |
|---|---|---|---|---|
| | Final body | gain | feed intake | Feed |
| Dietary | weight | (g gain/ | (g intake/ | conversion |
| treatments | (g/bird) | day bird) | day bird) | rate |
| Negative | 1581 | 39.5 | 70.6 | 1.79 |
| control | | | | |
| Positive | 1550 | 40.0 | 67.0 | 1.68 |
| control | | | | |
| Cellulose | 1593 | 40.7 | 68.8 | 1.69 |
| ester 1 | | | | |
| Cellulose | 1609 | 40.4 | 70.9 | 1.75 |
| ester 2 | | | | |
| Cellulose | 1606 | 41.6 | 70.3 | 1.69 |
| ester 3 | | | | |
| Cellulose | 1578 | 40.6 | 69.3 | 1.71 |
| ester 4 | | | | |

Poultry in Pellet Feed:

Materials and Methods

A group of 810 Ross 308 one day old male chickens were randomly distributed over 27 pens with 30 animals each. Pens were randomly assigned to one out of three treatments, one negative control and two with cellulose ester in two different concentrations. Water was freely available from drinking cups, and animals were fed ad libitum. A three-phase feeding scheme was applied for all pens. Starter, grower and finisher diets were formulated to meet energy and nutrient requirements according to CVB 2012 guidelines. The composition of the basal diets is shown in Table 1.2 and the nutrient composition is given in Table 2.2. The starter diet was provided from day 1 until day 13, the grower diet was provided from day 13 until day 28 and finisher diet was provided from day 28 until day 41.

TABLE 1.2
Ingredient composition of the experimental diet.

| Ingredient | Starter g/kg | Grower g/kg | Finisher g/kg |
|---|---|---|---|
| Wheat | 474.9 | 491.2 | 535.6 |
| Corn | 100.0 | 100.0 | 100.0 |
| Toasted soybean meal | 197.9 | 184.5 | 133.6 |
| Toasted extruded soybeans | 150.0 | 150.0 | 113.0 |
| Triglycerides | 35.5 | 23.7 | 23.5 |
| Soy oil | — | 12.3 | 19.4 |
| Corn gluten feed | — | — | 22.8 |
| Limestone | 20.3 | 17.8 | 17.7 |
| Sunflower meal | — | — | 12.0 |
| Mono calcium phosphate | — | — | 1.3 |
| Premix* | 20.0 | 20.0 | 20.0 |
| L-lysine HCl | 0.2 | — | 0.8 |
| DL-methionine | 0.5 | 0.2 | — |
| L-threonine | 0.6 | 0.2 | 0.2 |
| Phytase | 0.1 | 0.1 | 0.1 |

*Premix contains per kg of premix: vitamin A: 675 000 IU/kg, vitamin D3: 125 000 IU/kg, vitamin E: 2525 IU/kg, vitamin B1: 0.15 mg/kg, vitamin B2: 0.30 mg/kg, vitamin B3: 0.92 mg/kg, niacine: 2.23 mg/kg, vitamin B6: 0.34 mg/kg, vitamin B12: 1.69 mg/kg, biotine: 7.5 mg/kg, choline: 30 202 mg/kg, propylgallate: 0.04 mg/kg, citric acid: 30 mg/kg, Cu (from Cu sulphate): 563 mg/kg, Fe (from Fe sulphate): 3750 mg/kg, I (from Ca iodate): 56 mg/kg, Mn (from Mn oxide): 1846 mg/kg, Zn (from zinc sulphate): 3750 mg/kg, Se (from sodium selenite): 15 mg/kg.

TABLE 2.2
Nutrient composition of the experimental diets.

| Nutrient | Starter | Grower | Finisher |
|---|---|---|---|
| Dry matter, g/kg | 882.0 | 881.3 | 881.1 |
| Ash, g/kg | 53.8 | 50.6 | 48.3 |
| Crude protein, g/kg | 215.0 | 210.0 | 195.0 |
| Ether extract, g/kg | 79.5 | 80.0 | 80.0 |
| Crude fibre, g/kg | 32.0 | 31.9 | 32.0 |
| Nitrogen-free extract, g/kg | 501.7 | 508.8 | 525.8 |
| Metabolisable energy, kCal/kg | 2825 | 2860 | 2925 |
| Methionine, g/kg | 6.27 | 5.97 | 5.69 |
| Lysine, g/kg | 13.25 | 12.77 | 11.57 |
| P, g/kg | 3.91 | 3.87 | 4.00 |
| Ca, g/kg | 9.00 | 8.00 | 8.00 |
| Na, g/kg | 1.45 | 1.45 | 1.45 |

The basal formulation was used to produce the three experimental diets for each phase. For the negative control nothing was added, for the two doses of cellulose ester 2 or 4 kg/ton cellulose ester was added on top of the formulation as described in Table 3.2. AD diets were produced at a commercial feed mill and produced as a pelleted feed.

TABLE 3.2
Overview of the different treatments with the amount
of additive added on top of the blank feed.

| Dietary treatment | Number of pens | Starter | Grower | Finisher |
|---|---|---|---|---|
| Negative control | 7 | Blank feed | Blank feed | Blank feed |
| Cellulose ester 2 | 7 | 2 kg/ton | 2 kg/ton | 2 kg/ton |
| (CE2) | | cellulose | cellulose | cellulose |
| | | ester 2 | ester 2 | ester 2 |
| Cellulose ester 2 | 7 | 4 kg/ton | 4 kg/ton | 4 kg/ton |
| (CE2) | | cellulose | cellulose | cellulose |
| | | ester 2 | ester 2 | ester 2 |

From day 1 until day 41, the change in bodyweight was measured per pen together with feed intake per pen.

Results

The birds in the two cellulose ester groups had an increased final body weight compared to the negative control with a clear dose response effect. Consequently, average daily gain was increased as well. Feed conversion rate remained similar for all treatment groups. An overview of the results is show in Table 4.2.

TABLE 4.2
Effect of cellulose ester supplementation on broiler
chicken performance between 1 and 41 days of age.

| | | Average | Average daily | |
|---|---|---|---|---|
| | Final body | daily gain | feed intake | Feed |
| Dietary | weight | (g gain/ | (g intake/ | conversion |
| treatments | (g/bird) | day bird) | day bird) | rate |
| Negative control | 2147 | 50.3 | 89.4 | 1.78 |
| Cellulose ester 2 | 2351 | 55.6 | 99.4 | 1.79 |
| (CE2) (2 kg/ton) | | | | |
| Cellulose ester 2 | 2499 | 59.6 | 107.5 | 1.80 |
| (CE2) (4 kg/ton) | | | | |

Pigs in Pellet Feed:

Materials and Methods

A group of 192 weaned piglets (Topigs 20×Belgian Pietrain), 96 gilts and 96 chirurgically castrated barrows, were randomly distributed over 16 pens with 12 animals of the same sex each. Pens were randomly assigned to one out of two treatments, one negative control and one with cellulose ester in two different concentrations. Sex was evenly distributed over the two treatments, resulting in four pens of gilts and four pens of barrows per treatment. Water was freely available from drinking nipples, and animals were fed ad libitum. A two-phase feeding scheme was applied for all pens. Prestarter and starter diets were formulated to meet energy and nutrient requirements according to CVB 2012 guidelines. The composition of the basal diets is shown in Table 1.3 and the nutrient composition is given in Table 2.3. The prestarter diet was provided from day 1 until day 15, and the starter diet was provided from day 15 until day 36.

TABLE 1.3
Ingredient composition of the experimental diet.

| Ingredient | Prestarter g/kg | Starter g/kg |
|---|---|---|
| Barley | 250 | 250 |
| Wheat | 202 | 290 |
| Corn | 75 | 100 |
| Toasted soybean | 40 | 87 |
| meal | | |
| Toasted extruded | 120 | 120 |
| soybeans | | |
| Oatmeal extruded | 100 | — |
| Triglycerides | 6 | 10 |
| Wheat middlings | — | 25 |
| Sugar beet pulp | — | 15 |
| Organic acids | 3 | 3 |
| Sodium bicarbonate | 2 | — |
| Salt | 1 | — |
| Limestone | 1 | — |
| Premix* | 200 | 100 |

*Vitamin and mineral premix Prestart composition: 58 mg/kg propyl gallate, 75 000 IU/kg vitamin A, 10 000 IU/kg vitamin D3, 1 000 mg/kg vitamin E, 9 mg/kg vitamin K, 7 mg/kg vitamin B1, 40 mg/kg vitamin B2, 126 mg/kg vitamin B3, 25 mg/kg vitamin B6, 0.2 mg/kg vitamin B12, 253 mg/kg vitamin PP, 500 mg/kg vitamin C, 14 mg/kg folic acid, 1 mg/kg biotine, 2640 mg/kg choline, 244 mg/kg manganese oxide, 775 mg/kg copper sulphate, 520 mg/kg zinc chelate, 8 mg/kg calcium iodate anhydrate, 2 mg/kg sodium selenite, 5 000 FYT/kg 6-phytase, 53 IU/kg xylanase, 12 mg/kg sodium propionate, 40 mg/kg citric acid, 5 × 106 CFU Enterococcus faecium, 2% L-Lysine, 0.9% DL-Methionine, 0.2% Tryptophane, 0.9% L-Threonine, 0.2% L-Valine

Vitamin and mineral premix Start composition: 54 mg/kg propyl gallate, 150 000 IU/kg vitamin A, 20 000 IU/kg vitamin D3, 1 021 mg/kg vitamin E, 18 mg/kg vitamin K, 15 mg/kg vitamin B1, 80 mg/kg vitamin B2, 252 mg/kg vitamin B3, 49 mg/kg vitamin B6, 0.3 mg/kg vitamin B12, 505 mg/kg vitamin PP, 525 mg/kg vitamin C, 29 mg/kg folic acid, 2 mg/kg biotine, 4752 mg/kg choline, 1500 mg/kg iron sulphate, 493 mg/kg manganese oxide, 1550 mg/kg copper sulphate, 195 mg/kg zinc chelate, 15 mg/kg calcium iodate anhydrate, 4 mg/kg sodium selenite, 10 000 FYT/kg 6-phytase, 116 IU/kg xylanase, 11 mg/kg sodium propionate, 38 mg/kg citric acid, 4% L-Lysine, 2% DL-Methionine, 0.5% Tryptophane, 2% L-Threonine, 0.6% L-Valine

TABLE 2.3
Nutrient composition of the experimental diets.

| Nutrient | Prestarter | Starter |
|---|---|---|
| Dry matter, g/kg | 889.3 | 882.2 |
| Ash, g/kg | 52.1 | 48.6 |
| Crude protein, g/kg | 174.1 | 179.0 |
| Ether extract, g/kg | 51.2 | 52.9 |
| Crude fibre, g/kg | 39.6 | 39.9 |
| Nitrogen-free extract, g/kg | 572.3 | 561.8 |
| Net energy, kCal/kg | 2350 | 2350 |
| Methionine, g/kg | 4.5 | 4.6 |
| Lysine, g/kg | 12.4 | 12.3 |
| P, g/kg | 4.5 | 4.9 |
| Ca, g/kg | 4.6 | 5.6 |
| Na, g/kg | 2.5 | 1.4 |

The basal formulation was used to produce the two experimental diets for each phase. For the negative control nothing was added, for the one dose of cellulose ester, 4 kg/ton cellulose ester was added on top of the formulation as described in Table 3.3. All diets were produced at a commercial feed mill and produced as a pelleted feed.

TABLE 3.2
Overview of the different treatments with the amount
of additive added on top of the blank feed.

| Dietary treatment | Number of pens | Prestarter | Starter |
|---|---|---|---|
| Negative control | 8 | Blank feed | Blank feed |
| Cellulose ester 2 | 8 | 4 kg/ton | 4 kg/ton |
| (CE2) | | cellulose | cellulose |
| | | ester 2 | ester 2 |

From day 1 until day 36, the change in bodyweight was measure per pen together with feed intake per pen.

Results

The piglets in the group receiving 4 kg/ton cellulose ester in the diet had an improved feed conversion rate without affecting final body weight. This means that they grow at the same speed as the negative control group but more efficient because their feed intake is clearly lower when compared to the negative control group. An overview of the results is show in Table 4.2.

TABLE 4.3
Effect of cellulose ester supplementation on piglet
performance between 1 and 36 days of age.

| | | Average daily | Average daily | |
|---|---|---|---|---|
| | Final body | gain | feed intake | Feed |
| Dietary | weight | (g gain/ | (g intake/ | conversion |
| treatments | (g/pig) | day pig) | day pig) | rate |
| Negative | 17.1 | 306 | 468 | 1.53 |
| control | | | | |
| Cellulose | 17.1 | 300 | 446 | 1.49 |
| ester 2 | | | | |
| (CE2) | | | | |
| 4 kg/ton | | | | |

1. A method for the non-therapeutic treatment of poultry or pigs wherein said treatment comprises orally administering a feed or drinking water comprising at least one cellulose ester polymer [(CE) polymer, herein after], to poultry or pigs in an amount between 0.1 and 10 kg/ton of dry weight of said feed for the treatment of poultry or pigs, wherein more than 50% moles of recurring units of the (CE) polymer are recurring units (R_{CE}) of formula (I) as shown below: 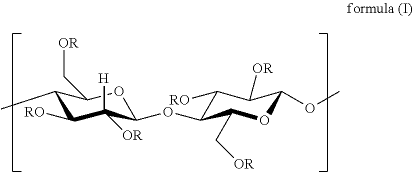
wherein each of R, equal to or different from each other, is H or an acyl group of general formula —(C═O)—R¹ wherein R¹ is an alkyl group having from 1 to 10 carbon atoms, and
wherein the (CE) polymer has a total acyl group content [TAG content, herein after] in the range of from 50 weight percent (wt %) to 60 wt %, relative to the total weight of the (CE) polymer.

2. (canceled)

3. The method according to claim 1, wherein each of R, equal to or different from each other, is H, an acetyl, a propionyl or a butyryl group.

4. The method according to claim 1, wherein the TAG content of the (CE) polymer, relative to the total weight of the (CE) polymer, in the range of from 45 wt. % to 55 wt. %.

5. The method according to claim 1, wherein the (CE) polymer has a butyryl group content of at least 5 wt relative to the total weight of the (CE) polymer.

6. The method according to claim 1, wherein the (CE) polymer has an average number of butyryl groups per AGU from 0.5 to 3.0.

7. The method according to claim 1, wherein the (CE) polymer has a number average molecular weight (Mₙ) ranging from 1,500 to 85,000.

8. The method according to claim 1, wherein the (CE) polymer is administered in an amount of at least 0.5 kg/ton relative to the dry weight of said feed or relative to the total weight of said drinking water.

9. The method according to claim 8, wherein the (CE) polymer is administered in an amount of less than 9 kg/ton relative to the dry weight of said feed or relative to the total weight of said drinking water.

10. The method according to claim 1, wherein the (CE) polymer is orally administered to poultry or pigs for the purpose of reducing the conversion ration of the feed used to feed poultry or pigs without lowering their bodyweight gain.

11. The method according to claim 1, wherein the (CE) polymer is orally administered to poultry or pigs for the purpose of increasing their bodyweight gain.

12. (canceled)

13. (canceled)

14. A feed composition for poultry or pigs comprising
a) a cellulose ester polymer [CE polymer] as defined in claim 6 and both of
b) one or more plant-based food ingredients in a collective amount of at least 50 dry weight percent (dry wt. %), based on the dry weight of the feed composition; and
c) one or more additional ingredients comprising anti-caking agents, vitamins, mineral, various amino acids, free-flowing agents, animal feed flavors or the like.

15. The feed composition of claim 14, wherein the feed composition is a feed wherein the amount of the CE polymer is between 0.1 and 10 kg/ton of the feed composition on a dry weight basis.

16. The feed composition according to claim 15, which comprises the (CE) polymer in an amount of less than 7 kg/ton dry weight of said feed composition.

17. The feed composition according to claim 16, which comprises said (CE) polymer in an amount of at least 0.5 kg/ton weight of said feed composition.

18. The feed composition of claim 14, wherein the feed composition is a premix.
